(19) United States
(12) Patent Application Publication
(10) Pub. No.: US 2014/0044345 A1
(43) Pub. Date: Feb. 13, 2014

(54) METHOD OF ANALYZING AND/OR PROCESSING AN IMAGE

(71) Applicant: E-ON SOFTWARE, Paris (FR)

(72) Inventors: Nicholas PHELPS, Paris (FR); Marc DE FALCO, Maisons-Alfort (FR)

(73) Assignee: E-ON SOFTWARE, Paris (FR)

(21) Appl. No.: 14/057,674

(22) Filed: Oct. 18, 2013

Related U.S. Application Data
(62) Division of application No. 13/047,475, filed on Mar. 14, 2011.

(30) Foreign Application Priority Data
Feb. 15, 2011 (FR) 11 51204
Feb. 15, 2011 (FR) 11 51205

(51) Int. Cl. G06T 5/00

(52) U.S. Cl. CPC G06T 5/00
USPC 382/154

(57) ABSTRACT

A method of processing a starting image, to obtain a final image of better quality, the method comprising the following steps: a) establishing a predefined quality level and/or a predefined processing time for the final image; b) computation information relating to said starting image; c) analyzing said starting image by means of said computed information; d) determining whether said information is sufficient to obtain said predefined quality level for said final image; e) if the step d) determines that the information is sufficient and/or if processing time is exhausted, reducing the noise of said starting image to obtain said final image; and f) if the step d) determines that the information is insufficient and/or processing time is not exhausted, refining the computation in the step b).

The present invention relates to a method of analyzing and/or processing a two-dimensional image.

### BACKGROUND OF THE INVENTION

This type of image processing method includes noise reduction methods, also known as denoising methods. The principle of noise reduction is derived from the processing of photographic images. The physical method of capturing optical information from the photographed subject necessarily leads to the presence of non-pertinent information in the form of noise. This is a consequence of the discrete nature of transmitting the optical information in the form of a stream of photons. Two-dimensional images produced by a photorealistic artificial image generation method are commonly called synthetic images. Photorealistic synthetic image generation using methods of simulating the physical transmission of light also generates noise. That noise is of a very different kind. It is generally the consequence of under-evaluating the information to be computed in order to reduce computation time. In particular, in a computation based on a random algorithm of the Monte Carlo or ray marching type, the number of samples actually processed is clearly insufficient to produce a quality evaluation of the computed phenomenon. Consequently, the result includes noise that is characteristic of the random component of the evaluation. The number of samples necessary to reduce the amplitude of the noise is proportional to the square of the required noise attenuation. Knowing that the quality of a synthetic image is linked among other things to the quantity of noise present in the image and knowing also that the cost of computing a synthetic image is directly linked to the number of samples, it is apparent that noise reduction techniques, which allows neighboring samples to be “re-used” to reduce the quantity of noise visible for a given number of samples, significantly reduces the overall cost of producing synthetic images or animations. The main characteristic of a photographic image compared to a synthetic image lies in the fleeting nature of the photographed subject. The information contained in a photograph is fixed at the moment of shooting. There are techniques for alleviating this problem, for example by capturing a series of photographs over a short time period in order to add more redundancy to the information of the image common to the series. In the context of generating a synthetic image there is no such fleetingness. The subject from which the image is generated is information that is permanent. It has been proposed, notably by Pixar, to modify the manner in which synthetic images are generated in order to improve the consistency of the noise in order to extract it in an optimized manner using a standard noise reduction technique that is not specific to synthetic images. However, to facilitate such modification, it is effected only upstream of noise reduction.

The present invention relates more particularly to a synthetic image noise reduction method of the above kind using feedback.

Another class of image data analysis methods includes methods that have the objective of improving the quality of the images or animations. Existing image analysis methods were developed conjointly with advances in digital photography. Those methods therefore treat the images as a color information grid. The association between a point of the grid and the color, grey level, or colorimetric information associated with it is called a pixel when the grid is two-dimensional and a voxel if it is three-dimensional. The images produced by three-dimensional sensors and consisting of voxels are characteristic of technologies originating in the medical domain. The analysis of those images uses three-dimensional information that is directly associated with them. Those methods are not applicable to two-dimensional images, however. Most two-dimensional images to which analysis methods are applied represent information having a three-dimensional geometrical character. It is therefore a question of a two-dimensional projection of the three-dimensional information. The three-dimensional information is crucial for the analysis of the image, however. It is for example only natural to envisage a blurring method preserving the dissociation between the subjects shown. Standard methods then proceed to reconstruct geometrical information about subjects present in the image, which is generally difficult. That type of method is complicated and is not of optimum efficiency. For numerous image analysis methods, such as noise reduction and extraction of singularities, it is essential to be able to establish whether two pixels are similar or not. In practice, this is estimated on the basis of the distance in colorimetric space over which the pixels have value. US2010141804 describes one such method. That type of method has the disadvantage of causing two pixels of potentially very different kinds in the subject of the image to be deemed similar.

The present invention also relates to that kind of method of analyzing data of a two-dimensional image.

### OBJECTS AND SUMMARY OF THE INVENTION

An object of the present invention is to overcome the problems referred to above.

One particular object of the present invention is to provide an image analysis and/or processing method that allows the quality of images to be improved.

A further object of the present invention is to provide a method of the above kind that is simple and of relatively low cost to implement.

Thus the present invention provides a method of processing a starting synthetic image to obtain a final synthetic image of better quality, the method comprising the following steps:

a) establishing a predefined quality level and/or a predefined processing time for the final synthetic image;

b) computing information relating to said starting synthetic image;

c) analyzing said starting synthetic image by means of said computed information;

d) determining whether said information is sufficient to obtain said predefined level of quality for said final synthetic image;

e) if the step d) determines that the information is sufficient and/or if processing time is exhausted, reducing the noise of said starting synthetic image to obtain said final synthetic image; and

f) if the step d) determines that the information is insufficient and/or processing time is not exhausted, refining the computation in the step b).

The step f) advantageously recomputes one or more additional samples for a pixel or a portion of the given image.

The step f) advantageously recomputes from a different camera position.

A noise reduction method is advantageously coupled to a synthetic image generation method.

Said steps b), c), and d) advantageously process pixels enriched with three-dimensional information from said starting synthetic image.

The predefined quality level in the step a) is advantageously an estimate of the variance of the information.

The predefined quality level in the step a) is advantageously a minimum quantity of information available in the image.

The predefined quality level in the step a) advantageously depends on local surface characteristics, for example roughness, reflectivity, transparency, and/or characteristics of the received light, for example brightness, ambient light, direct light, color, intensity, and/or UV coordinates.

Said method is advantageously applied to a sequence of two-dimensional images.

The present invention also provides a method of analyzing data from a two-dimensional image including the step of using pixels enriched with three-dimensional information.

The image is advantageously a synthetic image.

Said three-dimensional information is advantageously used to evaluate the similarity between the pixels of said image.

Said analysis of the image advantageously allows the quantity of noise present in said image to be reduced.

Said three-dimensional information advantageously includes one or more of the following: local normal, direction of movement, speed of movement, distance from camera, the material of the object, surface characteristics, for example roughness, reflectivity or transparency, characteristics of the received light, for example ambient light, direct light, color or brightness, UV coordinates.

Analyzing data from the image advantageously includes searching for image portions having similarities.

Analyzing data from the image advantageously includes extrapolating data from existing images guided by the three-dimensional information.

Said method is advantageously applied to a sequence of two-dimensional images.

### BRIEF DESCRIPTION OF THE DRAWINGS

The above and other features and advantages of the present invention become more clearly apparent in the course of the following detailed description of the invention, given with reference to the appended drawings, which are provided by way of non-limiting example, and in which:

FIG. 1 is a diagram of a control stream of a noise reduction method using feedback;

FIG. 2 is a synthetic image of a scene;

FIGS. 3 to 5 are views showing additional information relative to the FIG. 2 image; and

FIGS. 6 to 8 represent diagrammatically information linked to movements of objects in a scene.

### MORE DETAILED DESCRIPTION

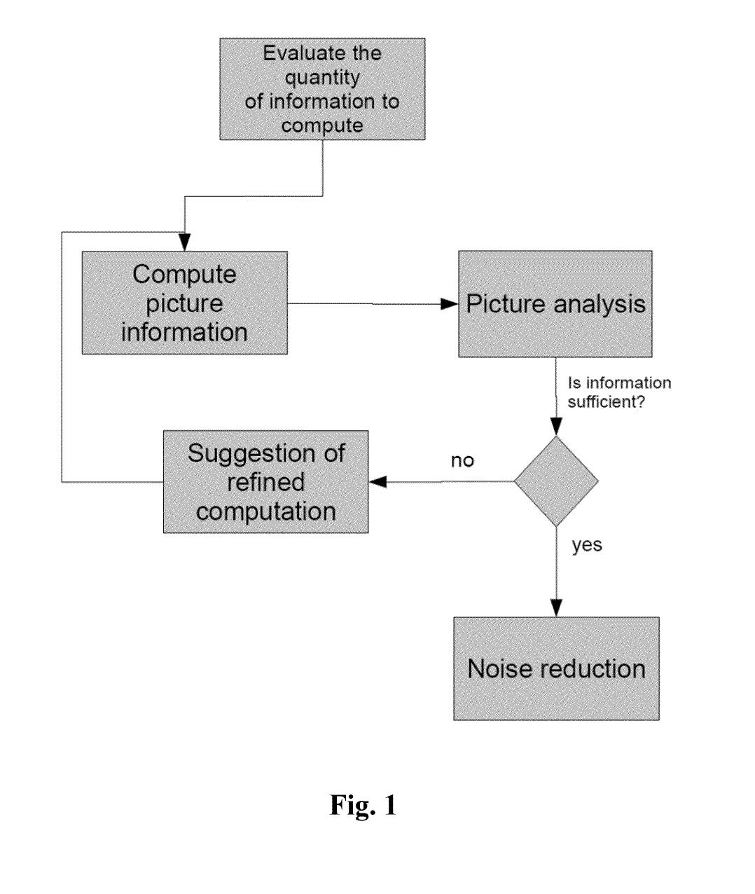

The image analysis method shown in FIG. 1 applies in particular to the generation of a synthetic image. As explained above, in contrast to a photographic image, there is no fleetingness in the context of generating a synthetic image. The subject from which the image is generated is information that is permanent. Thus it is possible to produce a synthetic image of the same subject at two different times. Where noise reduction is concerned, this means that the quantity of information contained in a synthetic image may be locally refined as required.

A first aspect of the invention proposes a synthetic image noise reduction environment relying on symbiosis between a noise reduction algorithm and a synthetic image generation method. This symbiosis is characterized by a two-way coupling between these two components. The synthetic image generation method then supplies a starting image to the noise reduction algorithm that, if it lacks information, sends feedback to the generation method.

Accordingly, an object of the method is to process a starting synthetic image to obtain a final synthetic image of better quality. To do this, the method uses an algorithm, typically a noise reduction algorithm. A predefined quality level is established for the final synthetic image and the algorithm computes information relating to said starting synthetic image. For example, said quality level may be expressed in the form of a maximum tolerated noise level, an estimate of the variance of the information, or a minimum number of samples found in the image and satisfying the criterion to be taken into account by the noise reduction algorithm. This quality level may also take into account local criteria such as local surface characteristics (for example roughness, reflectivity, transparency) and/or characteristics of the light received (for example brightness, ambient light, direct light, color, intensity, possibly differentiated by source) and/or UV coordinates, etc.

A total processing time for obtaining the final image may also be indicated, in which case processing of the image may continue until said processing time is exhausted. After analysis of said starting synthetic image by means of said computed information, the method determines whether said information is sufficient to obtain said predefined quality for said final synthetic image. If the method determines that the information is sufficient, and/or if processing time is exhausted, said starting synthetic image undergoes noise reduction to obtain said final synthetic image. In contrast, if the method determines that the information is insufficient, and/or if the processing time is not exhausted, it then proposes refining the previous computation. Such refinement may include computing additional samples for a given pixel, a given zone of the image or even the entire image or recomputing from a different camera position. It would thus be possible, for an object situated in penumbra, to request a back view to find out whether the object is receiving light and thus to differentiate it from other areas of penumbra.

The step of determining whether the information is sufficient to obtain said predefined level of quality for said final synthetic image could be replaced by a step of determining specific portions of said information, e.g. portions that represent the lowest quality.

The possibility that no predefined level of quality and/or processing time limit is established is also considered, in which case means of externally interrupting the process could be provided, and the process may continue until it is interrupted.

Adding information after a first analysis of a synthetic image is standard for solving aliasing problems, for example. However, it is then a question of analyzing the image obtained by local detection of variations in color, distance, or contrast. The final image is then produced by applying an averaging filter to these local samples.

In contrast, no technique exists at present that proposes analyzing all of the image or animation, for example with the object of detecting and using areas that are similar and then refining the computation locally, if necessary.

A noise reduction algorithm generally has two separate stages. In a first stage the algorithm analyzes the image supplied to its input in order to produce intermediate information that is then processed by the noise reduction part proper, which produces a new image.

The present method proposes analyzing a fixed subject for the synthetic image from a representation of the subject that is potentially very noisy. This information is then sent to the first pass of the image algorithm that may propose refining this information in some areas, if necessary. The total information computed may be accumulated by the noise reduction algorithm until information is obtained of sufficient quality to effect noise reduction and to provide the final image. This process is represented in FIG. 1.

Noise reduction and more generally image analysis algorithms take an overall approach to the image and the information that it contains. The contribution of the present method is the possibility of leaving it to the noise reduction algorithm to specify what information it wishes to refine.

It should be emphasized that the method described above remains valid in the context of analyzing sequences of images representing an animation. The refinement proposals should then refer to the areas of the image to be refined and to the temporal positions at which the computation should be effected.

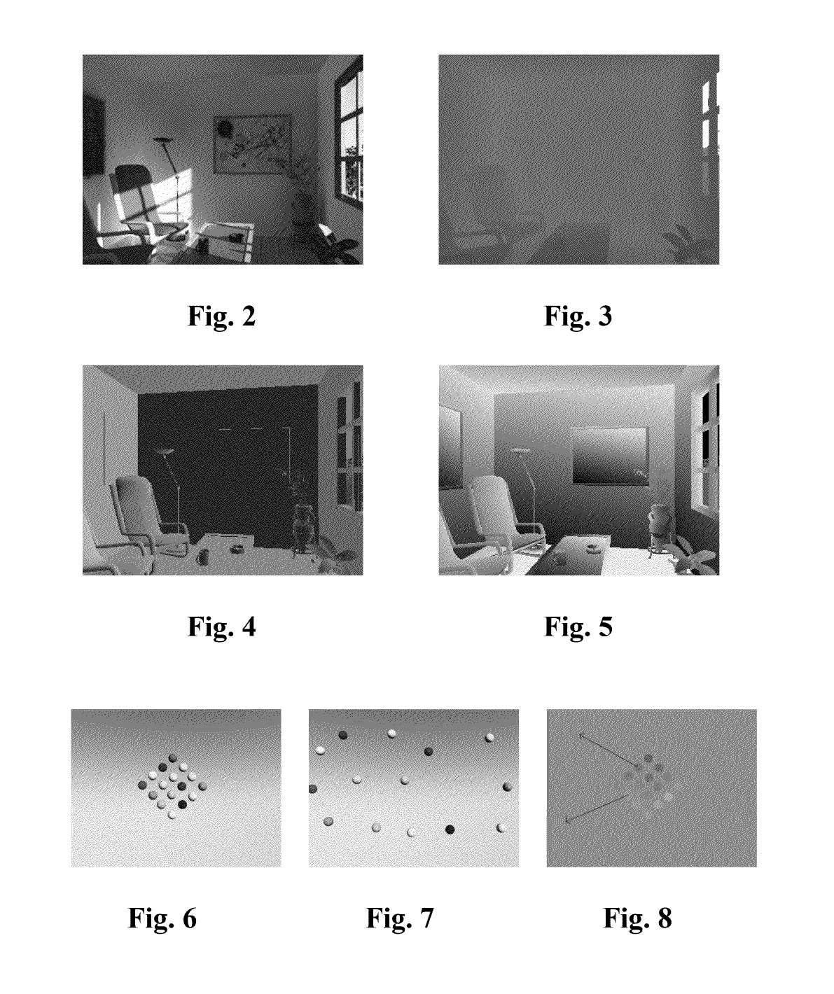

Another image analysis method, which constitutes a second aspect of the present invention, is described below with reference to FIGS. 2 to 8.

This method of analyzing data of a two-dimensional image, preferably a synthetic image, uses enriched pixels, i.e. pixels associated with three-dimensional information. The method therefore relates to the analysis of data of a two-dimensional image in possession of additional information resulting from the three-dimensional nature of its subjects. The objective is in particular to improve the quality of the image or the animation by re-using some data already present in the image or animation. In particular, the aim is to reduce the quantity of noise present in an image. The three-dimensional data may be obtained by means of coupling between a still camera and physical sensors or by means of a method of generating synthetic images from a three-dimensional representation.

Reference is made more particularly to generating synthetic images with the aid of geometrical descriptions, to the extent that this is favorable in terms of information availability. The synthetic image then makes it possible to provide methods that can be associated with the photographic sensor; the pertinence of an image analysis method vis-à-vis a specific enhancement could thus lead to introducing such an association.

FIG. 2 shows an image generated by a synthetic image generation method. Considerable geometrical information was used to produce this image. Broadly speaking, the geometric scene is divided into small triangles and information is obtained, such as the orientation of the vector normal to the surface or two-dimensional coordinates in order to be able to place a pattern on those surfaces.

FIG. 3 represents the camera distance information, also known as depth, associated with the FIG. 2 scene. This information is extrapolated from the point of impact on the surface at the point represented by a given pixel. Similarly, FIGS. 4 and 5 represent normal and texture coordinate information associated with the same image.

FIGS. 6 to 8 show information linked to the movement of objects in a scene. It is possible to extract a vector called the velocity vector giving, for a given pixel of an image at a given moment, its movement vector in the image space at the next moment.

Such information may be used for image analysis in two different ways. The first way, operationally very close to how artists use the information, divides the initial image into consistent areas with the aid of this information. Thus it would be possible to process separately the walls of a room and the objects that it contains. This approach is known in itself. The second way, using the present method, modifies existing image analysis techniques by taking this additional information directly into account as additional components associated with the color of a pixel. In particular, image data analysis consists in extrapolating from existing image data under guidance from the three-dimensional information.

There are numerous ways to do this, one of which is shown here by way of non-limiting example. The principle of the method of the invention is the general principle of analyzing enriched pixels.

Note also that the fixed images may be replaced by sequences of images representing an animation. The pertinence of the enhancements is then linked to their temporal consistency. It is thus necessary for two normals to successive images to be expressed in the same manner.

As explained above, the noise reduction method of the document FR 2 870 071 estimates whether two pixels are similar or not on the basis of the distance in colorimetric space over which the pixels have values. It is then possible, for example, for a pixel from a representation of a wall to have the same color as a pixel from a representation of a leaf of a tree. From the point of view of the result of the analysis, it may then be very bad to associate them. For example, the wall will tend to be present within a flat area whereas the contours of the leaf could be more jagged. Adding a simple criterion of proximity in image space is not sufficient, because it may be necessary to process two walls in a similar manner even though they are far apart in the image.

The present method uses three-dimensional information that allows the value space in which the distance is computed to be replaced by a more pertinent space. In particular two pixels may be considered similar if their colors and, for example, the normals to the surface on which they rest are similar. Thus in the above example the wall and the leaf are directly differentiated, at the same time making the two walls more similar.

The present method may also use the three-dimensional information to orient extrapolation from any of the two-dimensional or three-dimensional information contained in the image. With a sequence of images, for example, information on the movement of a pixel of an image can be used to extrapolate the position of said pixel for another time position.

The three-dimensional information that may be used more particularly includes local normal, direction of movement, speed of movement, distance from camera, the material of the object, or any other characteristic allowing objects to be discriminated, surface characteristics, for example roughness, reflectivity, transparency, characteristics of the received light, for example ambient light, direct light, color, intensity, where appropriate differentiated by source, UV coordinates, etc.

Note that the synthetic image processing method, in particular the noise reduction method, described with reference to FIG. 1 may also use pixels enriched with three-dimensional information, as described above with reference to FIGS. 2 to 8. Thus noise reduction can be optimized.

Although the present invention is described with reference to the implementations shown in the drawings, it should be understood that the person skilled in the art may be in a position to make any useful modifications without this departing from the scope of the present invention as defined by the appended claims.

1-10. (canceled)

11. A method of analyzing data from a two-dimensional image including the step of using pixels enriched with three-dimensional information.

12. A method according to claim 11, wherein the image is a synthetic image.

13. A method according to claim 11, wherein said three-dimensional information is used to evaluate the similarity between the pixels of said image.

14. A method according to claim 11, wherein said analysis of the image allows the quantity of noise present in said image to be reduced.

15. A method according to claim 11, wherein said three-dimensional information includes one or more of the following: local normal, direction of movement, speed of movement, distance from camera, the material of the object, surface characteristics, for example roughness, reflectivity or transparency, characteristics of the received light, for example ambient light, direct light, color or brightness, UV coordinates.

16. A method according to claim 11, wherein analyzing data from the image includes searching for image portions having similarities.

17. A method according to claim 11, wherein analyzing data from the image includes extrapolating data from existing images guided by the three-dimensional information.

18. A method according to claim 11, wherein said method is applied to a sequence of two-dimensional images.
